(19) United States
(12) Patent Application Publication
(10) Pub. No.: US 2025/0383956 A1
(43) Pub. Date: Dec. 18, 2025

(54) STORAGE CONTROLLER FOR CALCULATING ERROR LEVEL VALUE, METHOD OF OPERATING THE SAME, AND METHOD OF OPERATING STORAGE DEVICE INCLUDING THE SAME

(71) Applicant: SAMSUNG ELECTRONICS CO., LTD., Suwon-si (KR)

(72) Inventors: Pilwoong YANG, Suwon-si (KR); Dongeun Shin, Suwon-si (KR); Jinseob Yang, Suwon-si (KR)

(73) Assignee: SAMSUNG ELECTRONICS CO., LTD., Suwon-si (KR)

(21) Appl. No.: 19/052,807

(22) Filed: Feb. 13, 2025

(30) Foreign Application Priority Data
Jun. 12, 2024 (KR) 10-2024-0076537
Jul. 29, 2024 (KR) 10-2024-0100358

(51) Int. Cl. G06F 11/10; G06F 11/07

(52) U.S. Cl. CPC G06F 11/1016; G06F 11/0757; G06F 11/1068

(57) ABSTRACT

A method of operating a storage device includes performing, at a first time point, a read operation on a target memory region of the storage device, determining whether a first error level value of the read operation exceeds a threshold error level value, calculating, based on determining that the first error level value does not exceed the threshold error level value, a second error level value corresponding to a second time point, based on distribution model information, determining whether the second error level value exceeds the threshold error level value, and performing, at a third time point before the second time point, a reclaim operation on the target memory region, based on determining that the second error level value exceeds the threshold error level value. The second time point corresponds to a time point after a reference time period has elapsed from the first time point.

### CROSS-REFERENCE TO RELATED APPLICATIONS

This application claims benefit of priority under 35 U.S.C. § 119 to Korean Patent Application No. 10-2024-0076537, filed on Jun. 12, 2024, and to Korean Patent Application No. 10-2024-0100358, filed on Jul. 29, 2024, in the Korean Intellectual Property Office, the disclosures of which are incorporated by reference herein in their entireties.

### BACKGROUND

### 1. Field

The present disclosure relates generally to a storage device, and more particularly, to a storage controller for calculating an error level value, a method of operating the storage controller, and a method of operating a storage device including the storage controller.

### 2. Description of Related Art

A memory device may store data in response to a write request and may output data stored therein in response to a read request. For example, the memory device may be classified as a volatile memory device or as a non-volatile memory device. A volatile memory device may refer to a device that may lose data stored therein when a power is turned off, such as, but not limited to, a dynamic random access memory (DRAM) device, a static RAM (SRAM) device, or the like. A non-volatile memory device may refer to a device that may retain data stored therein even when a power is turned off, such as, but not limited to, a flash memory device, a phase-change RAM (PRAM), a magnetic RAM (MRAM), a resistive RAM (RRAM), or the like.

The non-volatile memory device may be used in a storage device storing a large amount of data. The storage device may perform a reclaim operation to maintain the reliability of data stored therein. The reclaim operation may include copying data stored in a memory region to any other memory region. The reclaim operation may reinforce the reliability of the stored data, however, the reclaim operation may cause an increase in power consumption and/or program/erase (P/E) cycles of the storage device. Thus, there exists a need for further improvements in storage devices, as the need for data reliability may be constrained by power consumption and/or P/E cycle requirements. Improvements are presented herein. These improvements may perform the reclaim operation in consideration of the error level value of the stored data.

### SUMMARY

One or more example embodiments of the present disclosure provide a storage controller calculating for an error level value, a method of operating the storage controller, and a method of operating a storage device including the storage controller.

According to an aspect of the present disclosure, a method of operating a storage device includes performing, at a first time point, a read operation on a target memory region of the storage device, obtaining a first error level value based on the performing of the read operation, determining whether the first error level value exceeds a threshold error level value, calculating, based on determining that the first error level value does not exceed the threshold error level value, a second error level value corresponding to a second time point, based on distribution model information indicating relationships between time points and error level values of the target memory region, determining whether the second error level value exceeds the threshold error level value, and performing, at a third time point before the second time point, a reclaim operation on the target memory region, based on determining that the second error level value exceeds the threshold error level value. The second time point corresponds to a time point after a reference time period has elapsed from the first time point.

According to an aspect of the present disclosure, a method of operating a storage controller includes providing, to a non-volatile memory device at a first time point, a read request of a target memory region of the non-volatile memory device, receiving, from the non-volatile memory device, first data corresponding to the read request, determining whether a first error level value of the first data exceeds a threshold error level value, calculating, based on determining that the first error level value does not exceed the threshold error level value, a second error level value corresponding to a second time point, based on distribution model information, determining whether the second error level value exceeds the threshold error level value, and providing, to the non-volatile memory device at a third time point before the second time point, a reclaim request of the target memory region, based on determining that the second error level value exceeds the threshold error level value. The second time point corresponds to a time point after a reference time period has elapsed from the first time point.

According to an aspect of the present disclosure, a storage controller includes a memory storing instructions, and one or more processors communicatively coupled to the memory. The instructions are configured to, when individually or collectively executed by the one or more processors, cause the storage controller to provide, to a non-volatile memory device at a first time point, a read request of a target memory region of the non-volatile memory device, receive, from the non-volatile memory device, first data corresponding to the read request, obtain a first error level value by performing a first error correction operation on the first data, determine whether the first error level value exceeds a threshold error level value, calculate, based on determining that the first error level value does not exceed the threshold error level value, a second error level value corresponding to a second time point, based on distribution model information, determine whether the second error level value exceeds the threshold error level value, calculate, based on determining that the second error level value exceeds the threshold error level value, a third time point before the second time point, and provide reclaim time point information indicating the third time point. The second time point corresponds to a time point after a reference time period has elapsed from the first time point.

Additional aspects may be set forth in part in the description which follows and, in part, may be apparent from the description, and/or may be learned by practice of the presented embodiments.

### BRIEF DESCRIPTION OF DRAWINGS

The above and other aspects, features, and advantages of certain embodiments of the present disclosure may be more apparent from the following description taken in conjunction with the accompanying drawings, in which:

FIG. 1 is a block diagram of an electronic device, according to an embodiment of the present disclosure;

FIG. 2 is a block diagram illustrating a storage controller of FIG. 1, according to some embodiments of the present disclosure;

FIG. 3 is a block diagram describing a non-volatile memory device of FIG. 1, according to some embodiments of the present disclosure;

FIG. 4 is a graph describing error level values of memory regions, according to some embodiments of the present disclosure;

FIG. 5 is a diagram describing a related storage device, according to some embodiments of the present disclosure;

FIG. 6 is a diagram describing a storage device, according to some embodiments of the present disclosure;

FIG. 7 is a flowchart describing a method of operating a storage device, according to some embodiments of the present disclosure;

FIG. 8 is a diagram describing a method of operating a storage device, according to some embodiments of the present disclosure;

FIG. 9 is a block diagram of an electronic device, according to some embodiments of the present disclosure;

FIG. 10 is a graph describing linear distribution model information of FIG. 9, according to some embodiments of the present disclosure;

FIG. 11 is a graph describing predictive distribution model information of FIG. 9, according to some embodiments of the present disclosure;

FIG. 12 is a graph describing a simulation of FIG. 9, according to some embodiments of the present disclosure;

FIG. 13 is a flowchart describing a method of operating a storage device, according to some embodiments of the present disclosure; and

FIG. 14 is a flowchart describing a method of operating a storage device, according to some embodiments of the present disclosure.

### DETAILED DESCRIPTION

The following description with reference to the accompanying drawings is provided to assist in a comprehensive understanding of embodiments of the present disclosure defined by the claims and their equivalents. Various specific details are included to assist in understanding, but these details are considered to be exemplary only. Therefore, those of ordinary skill in the art may recognize that various changes and modifications of the embodiments described herein may be made without departing from the scope and spirit of the disclosure. In addition, descriptions of well-known functions and structures are omitted for clarity and conciseness.

With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

The terms “first,” “second,” third” may be used to describe various elements but the elements are not limited by the terms and a “first element” may be referred to as a “second element”. Alternatively or additionally, the terms “first”, “second”, “third”, and the like may be used to distinguish components from each other and do not limit the present disclosure. For example, the terms “first”, “second”, “third”, and the like may not necessarily involve an order or a numerical meaning of any form.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, various embodiments of the present disclosure are described with reference to the accompanying drawings.

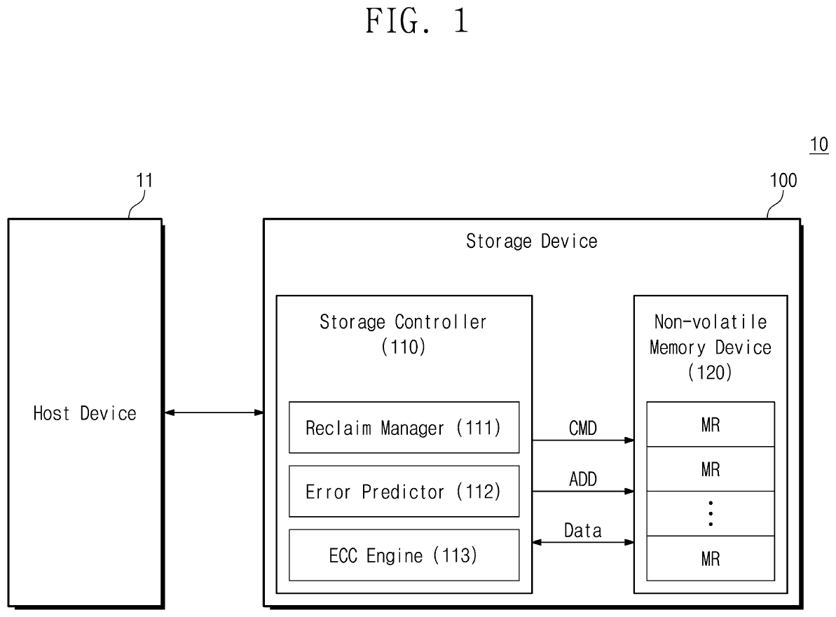

FIG. 1 is a block diagram of an electronic device, according to an embodiment of the present disclosure. Referring to FIG. 1, an electronic device 10 may include an electronic system configured to process a variety of information and/or to store the processed information as data. For example, the electronic device 10 may be implemented with a storage system, a server system, a database server, or the like for managing a large amount of user data. Alternatively or additionally, the electronic device 10 may be implemented with a computing system, which may be configured to process a variety of information, such as, but not limited to, a personal computer (PC), a notebook, a laptop, a server, a workstation, a tablet PC, a smartphone, a personal digital assistant (PDA), a digital camera, a wearable device (e.g., smart watch, headset, headphones, glasses, or the like), a smart device (e.g., a voice-controlled virtual assistant, a set-top box (STB), a refrigerator, an air conditioner, a microwave, a television (TV), or the like), an Internet-of-Things (IoT) device, and/or any other type of data processing device.

A host device 11 may control the operations of the electronic device 10. For example, the host device 11 may store data in a storage device 100, may read data stored in the storage device 100, and/or may delete data stored in the storage device 100.

The host device 11 may include a central processing unit (CPU), a graphic processing unit (GPU), a neural processing unit (NPU), or the like.

The storage device 100 may include a storage controller 110 and a non-volatile memory (NVM) device 120. Under control of the host device 11, the storage controller 110 may store data in the NVM device 120, may provide the stored data to the host device 11, and/or may delete the stored data.

The storage controller 110 may provide a command CMD and an address ADD to the NVM device 120. The command CMD may indicate an operation to be performed in the NVM device 120. The address ADD may indicate a location where the operation corresponding to the command CMD is to be performed. The storage controller 110 may communicate data with the NVM device 120. The data may include data to be written through the write operation, data read through the read operation, a response indicating a processing result of the command CMD, or the like.

The NVM device 120 may store data under control of the storage controller 110. The NVM device 120 may retain data present therein even though a power is turned off. For example, the NVM device 120 may be implemented with, but may not be limited to, a NAND flash memory device, a NOR flash memory device, a phase-change random-access memory (PRAM), a magnetic random-access memory (MRAM), a resistive random-access memory (RRAM), or the like.

The NVM device 120 may include a plurality of memory regions MR. Each memory region MR may refer to a physical region capable of storing data. For example, the memory region MR may correspond to a memory block, may correspond to memory cells connected to one word line, or may correspond to memory cells connected to a plurality of word lines.

The storage controller 110 may include a reclaim manager 111, an error predictor 112, and an error correction code (ECC) engine 113.

The reclaim manager 111 may manage the reclaim operation of the NVM device 120. The reclaim operation may refer to an operation of copying data stored in a memory region to another memory region to maintain a reliability of the stored data. For example, the reclaim operation may include reading data from an existing memory region, storing the read data in a new memory region, and deleting the data from the existing memory region.

For example, the memory region MR may include a transistor. Data may be stored by adjusting the amount of charges trapped by the transistor. The amount of trapped charges may vary due to various factors such as an elapsed time (retention), a read disturb, a read operation on an adjacent word line, and/or hot carrier injection (HCl). The change in the charge amount may cause error bits (e.g., bits determined to be different in value from a bit of stored data).

Typically, the error bits may be corrected by the ECC engine 113. However, when the number of error bits exceeds an error correction capability of the ECC engine 113, the error bits may be incapable of being corrected. Data including a number of error bits that exceed the error correction capability of the ECC engine 113 may be referred to as uncorrectable data. The reclaim manager 111 may read the stored data before the stored data becomes uncorrectable data, and may newly store the read data in another memory region.

That is, the reclaim operation may reinforce the reliability of the stored data. However, the reclaim operation may cause an increase in power consumption and a number of program/erase (P/E) cycles. Accordingly, there may be a need for a technique for performing the reclaim operation in consideration of an error level value (e.g., the number of error bits in the memory region MR) of the stored data before the stored data becomes uncorrectable data.

The error predictor 112 may predict the error level value of the memory region MR under control of the reclaim manager 111. The error predictor 112 may notify the reclaim manager 111 of a time point at which the error level value of the memory region MR may reach a threshold error level value. The threshold error level value may correspond to the maximum number of error bits correctable by the ECC engine 113. That is, the reclaim manager 111 may potentially reduce and/or suppress the increase in power consumption and a P/E cycle count without damaging the reliability of data, by triggering the reclaim operation at the time point as predicted by the error predictor 112.

The ECC engine 113 may perform an error correction operation within the error correction capability. The error correction capability may refer to the maximum number of error bits correctable by the ECC engine 113 for each memory region MR. For example, under control of the reclaim manager 111, the ECC engine 113 may receive data from the NVM device 120, may perform the error correction operation of the data, and may provide an error level value obtained by the error correction operation to the reclaim manager 111. The reclaim manager 111 may determine a point of time at which to perform the reclaim operation, based on the error level value.

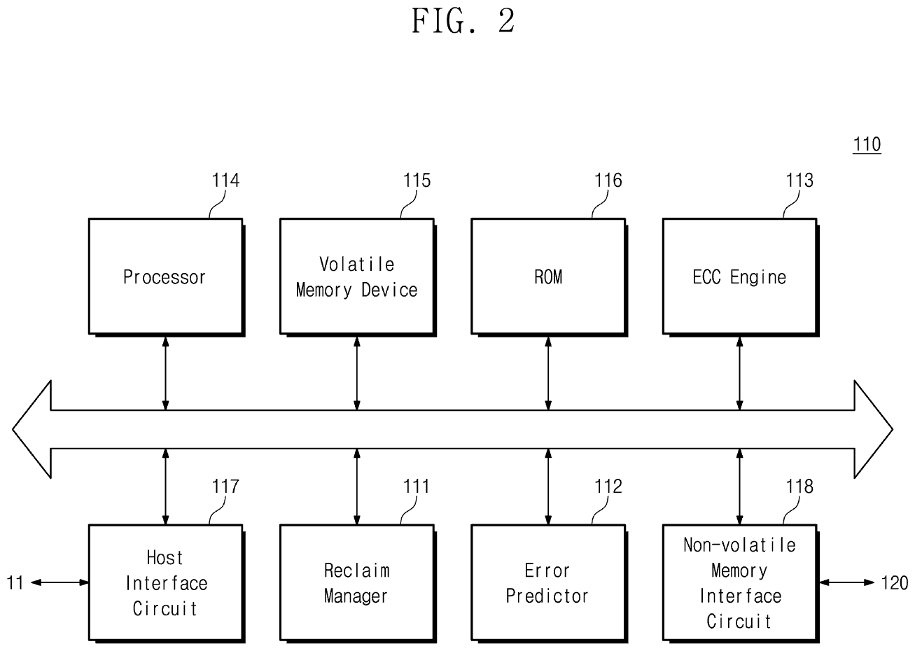

FIG. 2 is a block diagram illustrating a storage controller of FIG. 1, according to some embodiments of the present disclosure. Referring to FIGS. 1 and 2, the storage controller 110 may communicate with the host device 11 and the NVM device 120. The storage controller 110 may include the reclaim manager 111, the error predictor 112, the ECC engine 113, a processor 114, a volatile memory device 115, a read only memory (ROM) 116, a host interface circuit 117, and a non-volatile memory interface circuit 118. The reclaim manager 111, the error predictor 112, and the ECC engine 113 of FIG. 2 may include and/or may be similar in many respects to the reclaim manager 111, the error predictor 112, and the ECC engine 113 described above with reference to FIG. 1, and may include additional features not mentioned above. Consequently, repeated descriptions of the reclaim manager 111, the error predictor 112, and the ECC engine 113 described above with reference to FIG. 1 may be omitted for the sake of brevity.

The processor 114 may control the operations of the storage controller 110. In some embodiments, the processor 114 may be referred to as an embedded processor of the storage controller 110. The processor 114 may drive a firmware module by executing instructions loaded to the volatile memory device 115. The volatile memory device 115 may be implemented with a dynamic random access memory (DRAM), a static random access memory (SRAM), or the like. The volatile memory device 115 may function as a buffer memory, a logical-to-physical (L2P) mapping table, and/or a firmware memory. The ROM 116 may store information (e.g., data, instructions, or the like) that may be necessary for the operation of the storage controller 110.

At least some of the functions of the reclaim manager 111, the error predictor 112, and the ECC engine 113 may be implemented with a software module. For example, the processor 114 may implement at least some of the functions of the reclaim manager 111 and the error predictor 112 by loading instructions stored in the NVM device 120 to the volatile memory device 115 and executing the loaded instructions. Although FIG. 2 depicts the processor 114 as a single processor for the sake of convenience, the present disclosure is not limited in this regard. For example, the processor 114 may be and/or may include one or more processors that may, individually or collectively, execute the loaded instructions. Alternatively or additionally, at least one of the reclaim manager 111, the error predictor 112, and the ECC engine 113 may each be implemented by dedicated hardware including one or more of logic gates or circuits, registers, memories, interface circuits, etc. configured to perform the above-described functions in association with the processor 114.

The storage controller 110 may communicate with the host device 11 through the host interface circuit 117. In some embodiments, the host interface circuit 117 may be implemented based on at least one of various interfaces such as, but not limited to, an advanced technology attachment (ATA) interface, a serial ATA (SATA) interface, a peripheral component interconnect express (PCIe) interface, a small computer system interface (SCSI), a serial attached SCSI (SAS), a non-volatile memory express (NVMe) interface, a universal flash storage (UFS) interface, or the like.

The storage controller 110 may communicate with the NVM device 120 through the non-volatile memory interface circuit 118. In some embodiments, the non-volatile memory interface circuit 118 may be implemented based on the NAND interface.

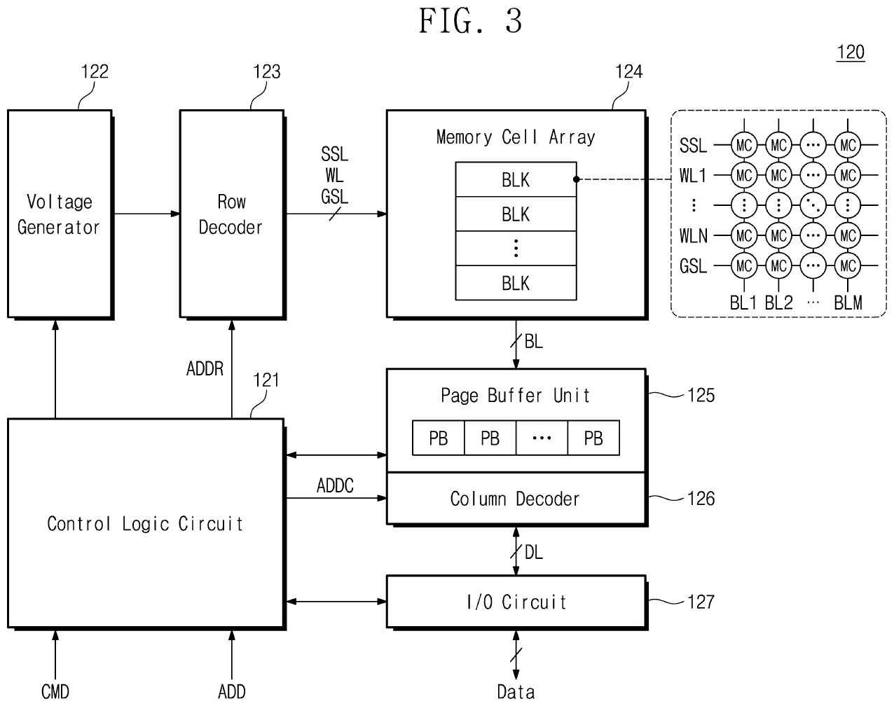

FIG. 3 is a block diagram describing a non-volatile memory device of FIG. 1, according to some embodiments of the present disclosure. Referring to FIGS. 1 and 3, the NVM device 120 may include a control logic circuit 121, a voltage generator 122, a row decoder 123, a memory cell array 124, a page buffer unit 125, a column decoder 126, and an input/output (I/O) circuit 127.

The control logic circuit 121 may receive the command CMD and the address ADD from the storage controller 110. The command CMD may refer to a signal indicating an operation to be performed by the NVM device 120, such as, but not limited to, a read operation, a write operation, an erase operation, or the like. The address ADD may include a row address ADDR and/or a column address ADDC. The control logic circuit 121 may generate the row address ADDR and the column address ADDC based on the address ADD.

In some embodiments, the control logic circuit 121 may drive an on-chip module.

Under control of the control logic circuit 121, the voltage generator 122 may control voltages to be applied to the memory cell array 124 through the row decoder 123.

The row decoder 123 may receive the row address ADDR from the control logic circuit 121. The row decoder 123 may be connected to the memory cell array 124 through string selection lines SSL, a plurality of word lines WL, and ground selection lines GSL. The row decoder 123 may decode the row address ADDR and may control voltages to be applied to the string selection lines SSL, the plurality of word lines WL, and the ground selection lines GSL based on a decoding result and voltages received from the voltage generator 122.

The memory cell array 124 may include a plurality of memory blocks BLK. Each of the plurality of memory blocks BLK may be connected to a string selection line SSL, the plurality of word lines (e.g., a first word line WL1 to a N-th word line WLN, where N is a positive integer greater than zero (0)), a ground selection line GSL, and a plurality of bit lines (e.g., a first bit line BL1 to an M-th bit line BLM, where M is a positive integer greater than zero (0)).

Each of the plurality of memory blocks BLK may include a plurality of memory cells MC. Each memory cell MC may correspond to a transistor. The memory cell MC may include a charge trap region. Data may be stored in the memory cell MC by adjusting the amount of charges trapped in the charge trap region.

The plurality of memory cells MC may be controlled by a voltage received through at least one of the string selection line SSL, the first to N-th word lines WL1 to WLN, and the ground selection line GSL. The plurality of memory cells MC may output data through at least one of the first to M-th bit lines BL1 to BLM.

In some embodiments, some of the plurality of memory cells MC may correspond to the memory region MR of FIG. 1. For example, the memory region MR may correspond to one memory block BLK, may correspond to memory cells connected to one word line WL, or may correspond to memory cells connected to one word line group including at least two word lines WL.

The page buffer unit 125 may include a plurality of page buffers PB. The page buffer unit 125 may be connected to the memory cell array 124 through the plurality of bit lines BL. The page buffer unit 125 may read data from the memory cell array 124 in units of page, by sensing voltages of the plurality of bit lines BL.

The column decoder 126 may receive the column address ADDC from the control logic circuit 121. The column decoder 126 may decode the column address ADDC and may provide the data read by the page buffer unit 125 to the I/O circuit 127 based on a decoding result.

The column decoder 126 may receive data from the I/O circuit 127 through data lines DL. The column decoder 126 may receive the column address ADDC from the control logic circuit 121. The column decoder 126 may decode the column address ADDC and may provide the data received from the I/O circuit 127 to the page buffer unit 125 based on a decoding result. The control logic circuit 121 may store data in the memory cell array 124 by controlling the voltage generator 122 and the row decoder 123 by referring to data stored in the page buffer unit 125.

The I/O circuit 127 may be connected to the column decoder 126 through the data lines DL. The I/O circuit 127 may receive data from the storage controller 110 and may transfer the received data to the column decoder 126 through the data lines DL. The I/O circuit 127 may receive data from the column decoder 126 through the data lines DL and may provide the received data to the storage controller 110.

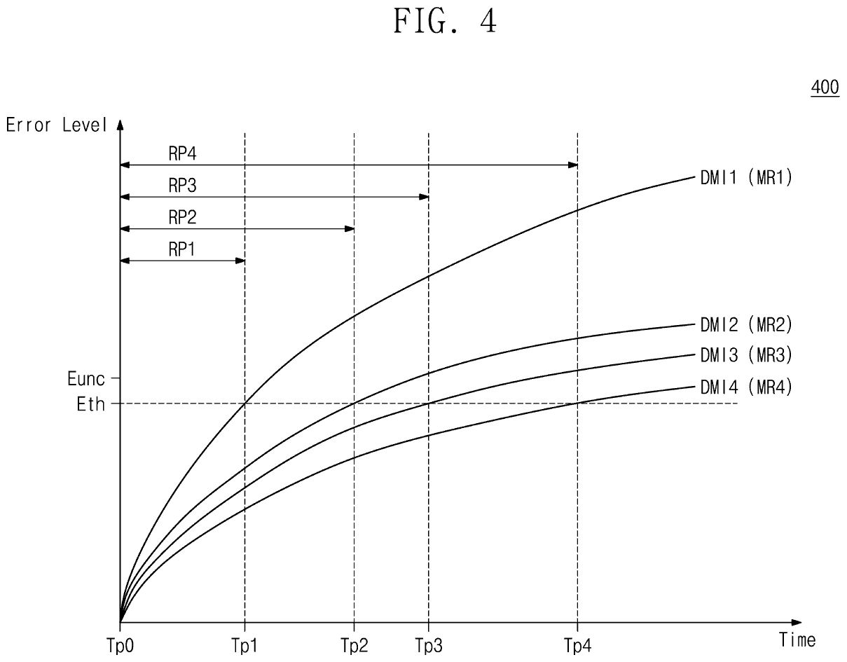

FIG. 4 is a graph describing error level values of memory regions, according to some embodiments of the present disclosure. Error levels of first to fourth memory regions MR1 to MR4 are be described with reference to graph 400 of FIG. 4. The first to fourth memory regions MR1 to MR4 may correspond to the memory areas MR of FIG. 1. In FIG. 4, the horizontal axis represents a time, and the vertical axis represents an error level.

A first distribution model information DMI1 indicates an error level over time of the first memory region MR1. Similarly, second to fourth distribution model information DMI2 to DMI4 indicate error levels over time of the second to fourth memory regions MR2 to MR4, respectively. A threshold error level value Eth may indicate the maximum number of error bits correctable by the ECC engine 113 of FIG. 1. The threshold error level value Eth may be smaller than an uncorrectable error level value Eunc. The uncorrectable error level value Eunc may indicate the number of error bits that may exceed the error correction capability of the ECC engine 113 of FIG. 1.

At a zeroth time point Tp0, the first to fourth memory regions MR1 to MR4 may have data stored therein. Immediately after the data are stored, the error level values of the first to fourth memory regions MR1 to MR4 may be zero (0) or may be substantially similar to zero (0). However, as time passes, the error levels of the first to fourth memory regions MR1 to MR4 may increase at different rates, as shown in graph 400.

At a first time point Tp1, the error level value of the first memory region MR1 may reach the threshold error level value Eth. That is, a reclaim operation of the first memory region MR1 may need to be performed at a first reclaim period RP1.

At a second time point Tp2, the error level value of the second memory region MR2 may reach the threshold error level value Eth. That is, a reclaim operation of the second memory region MR2 may need to be performed at a second reclaim period RP2.

At a third time point Tp3, the error level value of the third memory region MR3 may reach the threshold error level value Eth. That is, a reclaim operation of the third memory region MR3 may need to be performed at a third reclaim period RP3.

At a fourth time point Tp4, the error level value of the fourth memory region MR4 may reach the threshold error level value Eth. That is, a reclaim operation of the fourth memory region MR4 may need to be performed at a fourth reclaim period RP4.

As described above, the tendencies (e.g., rates of increase) of the error levels of the first to fourth memory regions MR1 to MR4 may be different from each other. As such, when the reclaim operations of the first to fourth memory regions MR1 to MR4 are performed at the first reclaim period RP1, a power consumption and/or a P/E cycle may be squandered (e.g., unnecessary) in association with the second to fourth memory regions MR2 to MR4. However, when the reclaim operations of the first to fourth memory regions MR1 to MR4 are performed at the fourth reclaim period RP4, the reliability of data stored in the first to third memory regions MR1 to MR3 may be damaged.

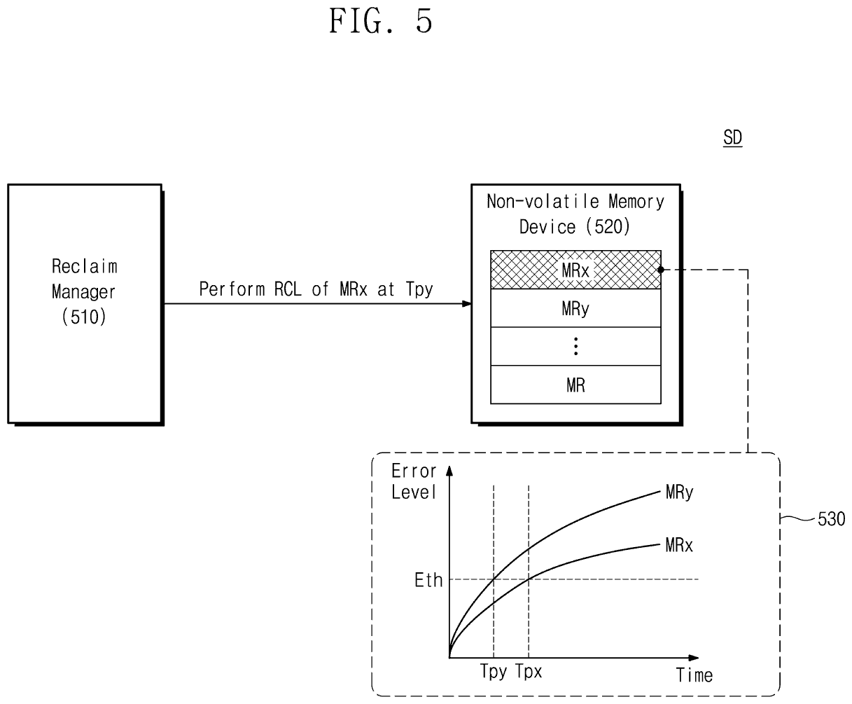

FIG. 5 is a diagram describing a related storage device, according to some embodiments of the present disclosure. A related storage device SD is described with reference to FIG. 5. However, the related storage device SD is not intended to limit the scope of the present disclosure.

The related storage device SD may include a reclaim manager 510 and a non-volatile memory (NVM) device 520. The NVM device 520 may include a plurality of memory regions MR. The plurality of memory regions MR may include a first target memory region MRx and a second target memory region MRy. The first target memory region MRx may refer to a target memory region where a reclaim operation RCL is to be performed. The second target memory region MRy may refer to a memory region having the highest error level value from among the plurality of memory regions MR. The second target memory region MRy may also be referred to as a poor memory region.

The error level tendency of the first target memory region MRx and the error level tendency of the second target memory region MRy are described with reference to graph 530. In the graph 530 of FIG. 5, the horizontal axis represents a time, and the vertical axis represents an error level. The error level value of the first target memory region MRx may reach the threshold error level value Eth at a first target time point Tpx. The error level value of the second target memory region MRy may reach the threshold error level value Eth at a second target time point Tpy.

The reclaim manager 510 may not refer to distribution model information of the first target memory region MRx. To maintain the reliability, the reclaim manager 510 may determine that the plurality of memory regions MR correspond to the second target memory region MRy and may perform the reclaim operation RCL based on the error level tendency of the second target memory region MRy.

For example, because the error level value of the first target memory region MRx does not reach the threshold error level value Eth before the first target time point Tpx, the reclaim operation RCL may not be needed. However, because the reclaim manager 510 does not refer to the distribution model information of the first target memory region MRx, the reclaim manager 510 may determine that the error level value of the first target memory region MRx is high like the error level value of the second target memory region MRy and may perform the reclaim operation RCL of the first target memory region MRx at the second target time point Tpy.

That is, the reclaim manager 510 may perform the reclaim operation RCL on all the memory regions MR at a reclaim period corresponding to the second target time point Tpy of the second target memory region MRy.

Consequently, the reclaim operation RCL may be performed unnecessarily frequently based on the second target memory region MRy without considering the tendency of the error level of each of the plurality of memory regions MR. Accordingly, power consumption may increase, I/O of data may be delayed, and a P/E cycle count may increase. For example, the increase in the P/E cycle count may reduce a projected lifetime of the storage device SD. To reduce and/or prevent these issues, there may be a need for a technique for performing the reclaim operation in consideration of the tendency of the error level of each memory region MR.

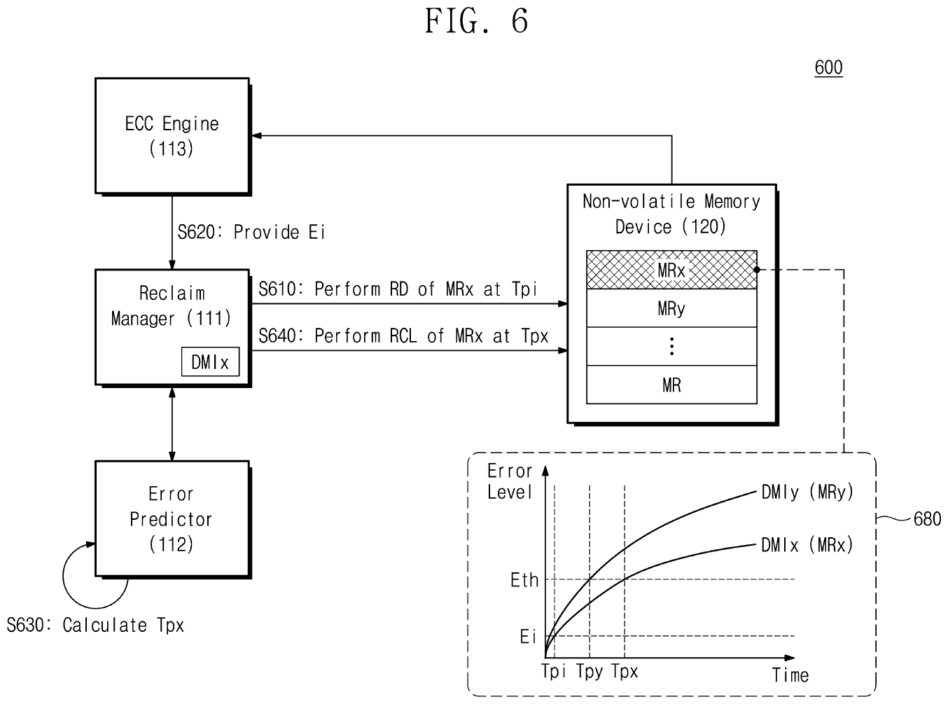

FIG. 6 is a diagram describing a storage device, according to some embodiments of the present disclosure. Referring to FIG. 6, the storage device 600 may include the reclaim manager 111, the error predictor 112, the ECC engine 113, and the NVM device 120. The reclaim manager 111, the error predictor 112, the ECC engine 113, and the NVM device 120 of FIG. 6 may include and/or may be similar in many respects to the reclaim manager 111, the error predictor 112, and the ECC engine 113 described above with reference to FIGS. 1 and 2, and may include additional features not mentioned above. Consequently, repeated descriptions of the reclaim manager 111, the error predictor 112, the ECC engine 113, and the NVM device 120 described above with reference to FIGS. 1 and 2 may be omitted for the sake of brevity.

The reclaim manager 111 may manage the reclaim operation RCL. Under control of the reclaim manager 111, the error predictor 112 may calculate the first target time point Tpx at which the error level reaches the threshold error level value Eth. The ECC engine 113 may perform the error correction operation of raw data received from the NVM device 120. The NVM device 120 may include the plurality of memory regions MR. The plurality of memory regions MR may include the first target memory region MRx and the second target memory region MRy. The first target memory region MRx may refer to a target memory region where the reclaim operation RCL is to be performed. The second target memory region MRy may refer to a memory region having the highest error level value from among the plurality of memory regions MR. The second target memory region MRy may also be referred to as a poor memory region.

An example of a method of operating the storage device 600 of the present disclosure is described with reference to FIG. 6.

In a first operation S610, the reclaim manager 111 may perform a read operation RD of the first target memory region MRx of the NVM device 120 at an initial time point Tpi. The read operation RD may be irrelevant to a read request of the host device 11. That is, the read operation RD may not be in response to a read request of the host device 11. The read operation RD may also be referred to as a dummy read operation, and may be performed for determining whether the reclaim operation RCL is needed.

A first target distribution model information DMIx of the first target memory region MRx and a second target distribution model information DMIy of the second target memory region MRy are described with reference to graph 680. In the graph 680 of FIG. 6, the horizontal axis represents a time, and the vertical axis represents an error level. The reclaim manager 111 may store the first target distribution model information DMIx. At the initial time point Tpi, the first target memory region MRx may have an initial error level value Ei. The initial error level value Ei may be smaller than the threshold error level value Eth.

In a second operation S620, the ECC engine 113 may receive the raw data corresponding to the read operation RD from the first target memory region MRx of the NVM device 120. The ECC engine 113 may perform the error correction operation of the raw data, may obtain the initial error level value Ei by the error correction operation, and may provide the initial error level value Ei to the reclaim manager 111.

In a third operation S630, the reclaim manager 111 may provide the first target distribution model information DMIx of the first target memory region MRx to the error predictor 112. The error predictor 112 may calculate the first target time point Tpx, at which the first target memory region MRx is predicted as having the threshold error level value Eth, based on the first target distribution model information DMIx. The reliability of data stored in the first target memory region MRx may be maintained until the first target time point Tpx. The error predictor 112 may provide information about the first target time point Tpx to the reclaim manager 111.

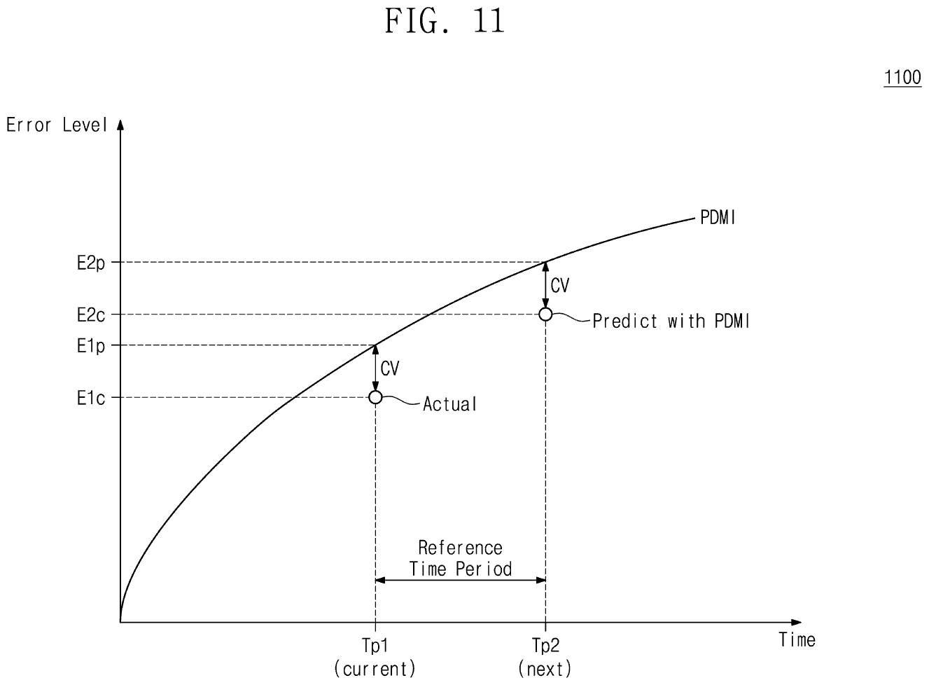

In some embodiments, the reclaim manager 111 may correct the first target distribution model information DMIx by referring to the initial time point Tpi and the initial error level value Ei. For example, the reclaim manager 111 may further provide information about the initial time point Tpi and the initial error level value Ei to the error predictor 112. The error predictor 112 may correct the first target distribution model information DMIx based on the initial time point Tpi and the initial error level value Ei and may calculate the first target time point Tpx corresponding to the threshold error level value Eth based on the corrected model information. The corrected model information is described with reference to FIG. 11.

In a fourth operation S640, the reclaim manager 111 may perform the reclaim operation RCL of the first target memory region MRx at the first target time point Tpx. The first target time point Tpx may be later than (e.g., after) the second target time point Tpy at which the error level of the second target memory region MRy reaches the threshold error level value Eth. That is, the first target time point Tpx may be after the second target memory region MRy has become a poor memory region.

According to embodiments of the present disclosure, instead of performing the reclaim operation RCL depending on a condition of a poor memory region, the reclaim operation may be performed at the first target time point Tpx that may be individually predicted in association with the first target memory region MRx by using the first target distribution model information DMIx. Accordingly, power consumption of the storage device 600 may be reduced, a P/E cycle count may be decreased, and/or a device lifetime may be improved, when compared to a related storage device.

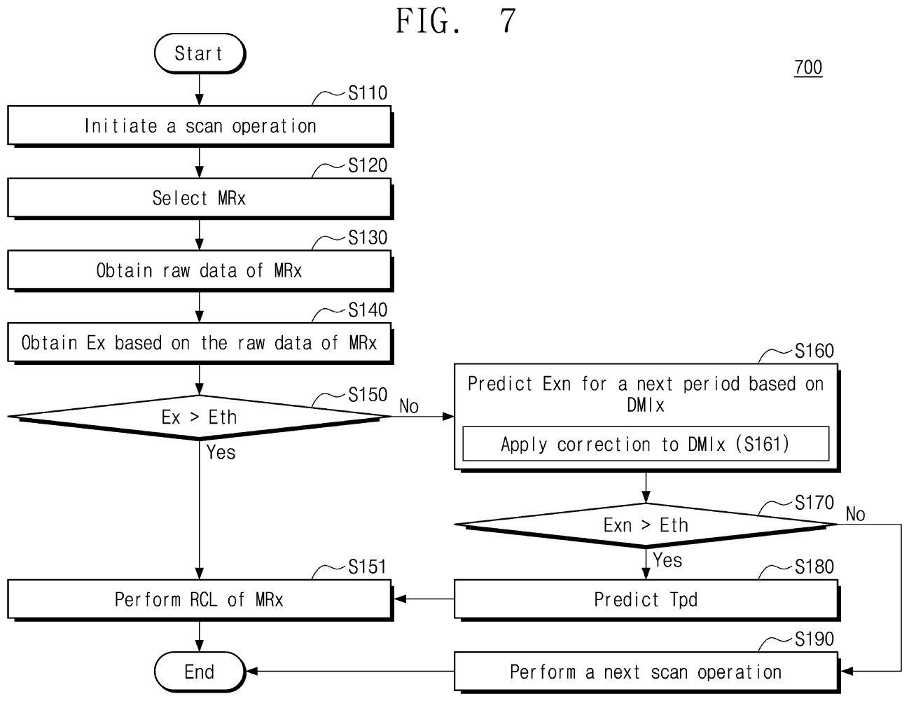

FIG. 7 is a flowchart describing a method of operating a storage device, according to some embodiments of the present disclosure. An example of a method 700 of operating a storage device (e.g., storage device 100 of FIG. 1 or storage device 600 of FIG. 6) is described with reference to FIG. 7.

In operation S110, the storage device may initiate a scan operation. The scan operation may refer to an operation of checking a degree of deterioration of stored data depending on a defense code.

In operation S120, the storage device may select the first target memory region MRx depending on the scan operation. For example, the storage device may select the first target memory region MRx based on the scan operation initiated according to the defense code.

In operation S130, the storage device may obtain raw data by performing a dummy read operation of the first target memory region MRx. The raw data may include at least one error bit.

In operation S140, the storage device may obtain an error level value Ex based on the raw data of the first target memory region MRx. For example, the storage device may include an ECC engine 113. The ECC engine 113 may perform the error correction operation of the raw data and may generate the error level value Ex corresponding to the number of corrected error bits.

In operation S150, the storage device may determine whether the error level value Ex exceeds the threshold error level value Eth. When the error level value Ex exceeds the threshold error level value Eth (Yes at operation S150), the storage device may perform operation S151.

In operation S151, the storage device may perform the reclaim operation RCL of the first target memory region MRx. That is, when the error level value Ex exceeds the threshold error level value Eth, the storage device may immediately perform the reclaim operation RCL of operation S151.

Returning to operation S150, when the error level value Ex does not exceed the threshold error level value Eth (No at operation S150), the storage device may perform operation S160.

In operation S160, the storage device may predict an error level value Exn for a next period, based on the first target distribution model information DMIx of the first target memory region MRx. For example, the storage device may periodically repeat the scan operation. A time period between the scan operation and the next scan operation may be referred to as a reference time period. The error level value Exn may indicate a predicted error level value of the first target memory region MRx depending on the first target distribution model information DMIx at a time point at which the next scan operation following the scan operation in operation S110 is to be performed.

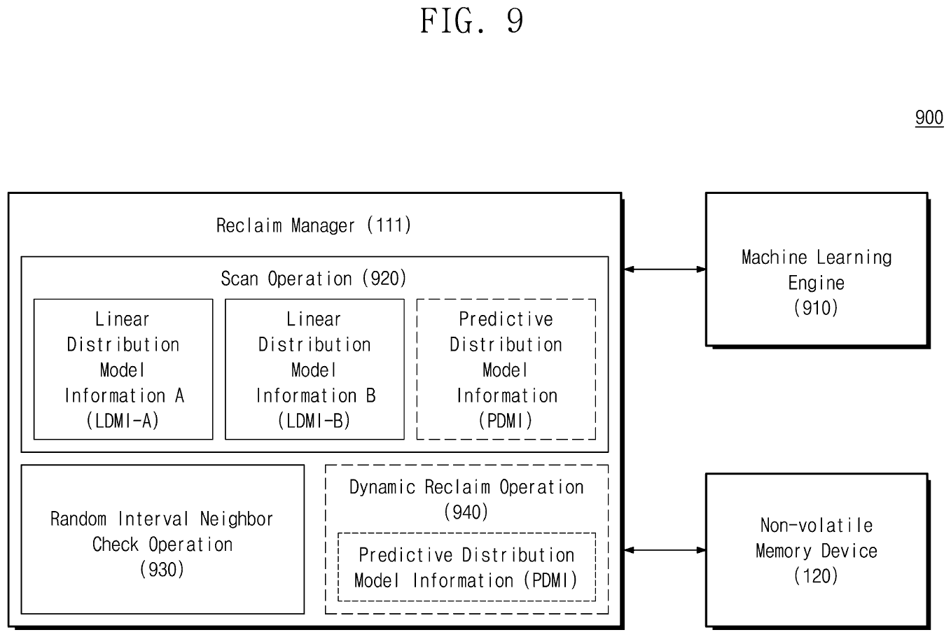

In some embodiments, the first target distribution model information DMIx may include linear distribution model information and/or predictive distribution model information, as described with reference to FIGS. 9 to 11.

Operation S160 may include operation S161. In operation S161, the storage device may apply a correction to the first target distribution model information DMIx. For example, the first target distribution model information DMIx may indicate relationships between time points and error level values of the first target memory region MRx by using a graph (e.g., graph 400 of FIG. 4 or graph 680 of FIG. 6). A pair of a time point at which the scan operation in operation S110 is performed and the error level value obtained in operation S140 may be referred to as coordinate data. The coordinate data may not be on the graph of the first target distribution model information DMIx. The first target distribution model information DMIx may be used to predict the error level value Exn by applying correction corresponding to a difference of the coordinate data and the graph, as described with reference to FIG. 11.

In operation S170, the storage device may determine whether the error level value Exn exceeds the threshold error level value Eth. When the error level value Exn exceeds the threshold error level value Eth (Yes at operation S170), the storage device may perform operation S180.

In operation S180, the error predictor 112 may predict a threshold time point at which the first target memory region MRx has the threshold error level value Eth. The storage device may predict a time point Tpd that may be the same as the threshold time point or may be earlier than the threshold time point, based on task scheduling information indicating a schedule of tasks to be internally processed. The storage device may reserve the reclaim operation RCL of the first target memory region MRx so as to be performed at the time point Tpd.

Afterwards, in operation S151, the storage device may perform the reclaim operation RCL of the first target memory region MRx. When operation S151 is performed after operation S180, the storage device may perform the reclaim operation RCL at the time point Tpd.

Returning to operation S170, when the error level value Exn does not exceed the threshold error level value Eth (No at operation S170), the storage device may perform operation S190.

In operation S190, the storage device may perform the next scan operation. For example, in response to determining that the error level value Exn does not exceed the threshold error level value Eth, the storage device may perform a next read operation of the first target memory region MRx as the next scan operation at a time point at which the reference time period passes from a time point at which the scan operation in operation S110 is performed. That is, the storage device may again perform operation S110 at the next period.

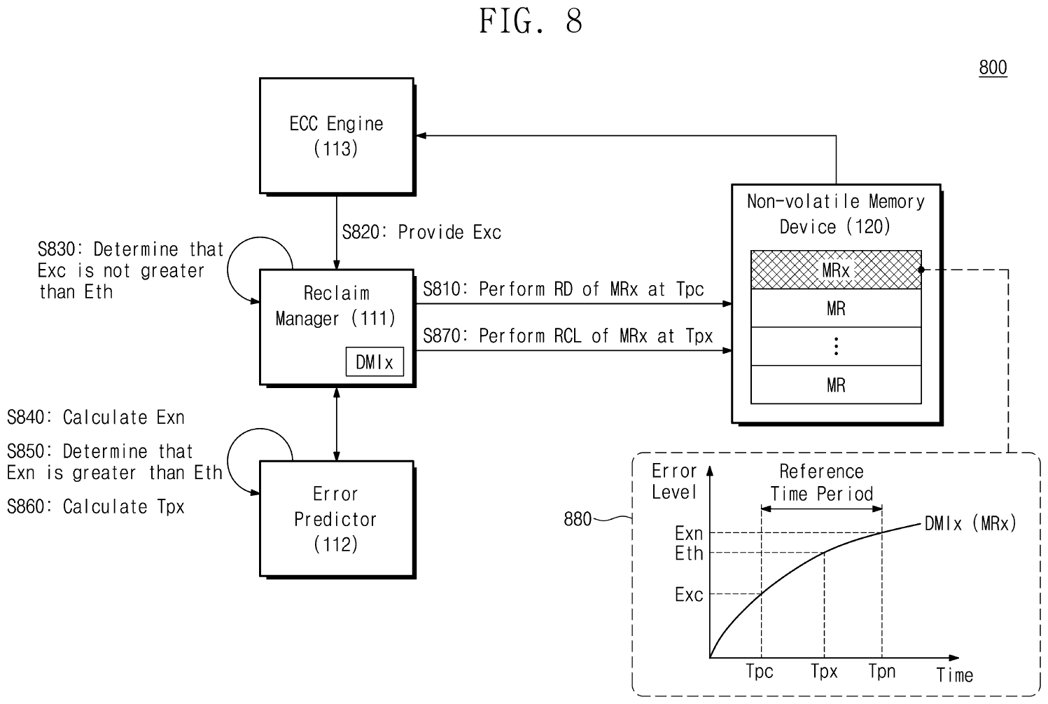

FIG. 8 is a diagram describing a method of operating a storage device, according to some embodiments of the present disclosure. Referring to FIG. 8, the storage device 800 may include the reclaim manager 111, the error predictor 112, the ECC engine 113, and the NVM device 120. The reclaim manager 111, the error predictor 112, the ECC engine 113, and the NVM device 120 of FIG. 8 may include and/or may be similar in many respects to the reclaim manager 111, the error predictor 112, the ECC engine 113, and the NVM device 120 described above with reference to FIGS. 1, 2, and 6, and may include additional features not mentioned above. Consequently, repeated descriptions of the reclaim manager 111, the error predictor 112, the ECC engine 113, and the NVM device 120 described above with reference to FIGS. 1, 2, and 6 may be omitted for the sake of brevity.

The NVM device 120 may include the plurality of memory regions MR. One of the plurality of memory regions MR may be the first target memory region MRx. The first target memory region MRx may also be referred to as a target memory region.

The first target memory region MRx may correspond to a plurality of memory cells. For example, the NVM device 120 may include a plurality of memory blocks. Each of the plurality of memory blocks may be connected to a plurality of word lines. The first target memory region MRx may correspond to one memory block among a plurality of memory blocks, may correspond to memory cells connected to one word line among a plurality of word lines, or may correspond to memory cells connected to one word line group including at least two word lines among the plurality of word lines.

An example of a method of operating the storage device 800 of the present disclosure is described with reference to FIG. 8.

In a first operation S810, the reclaim manager 111 may perform the read operation RD of the first target memory region MRx of the NVM device 120 at a current time point Tpc. For example, the reclaim manager 111 may provide the NVM device 120 with a read request indicating the read operation RD.

The first target distribution model information DMIx of the first target memory region MRx is described with reference to graph 880. In the graph 880 of FIG. 8, the horizontal axis represents a time, and the vertical axis represents an error level. At the current time point Tpc, the first target memory region MRx may have a current error level value Exc. At a next time point Tpn at which the reference time period passes from the current time point Tpc, the first target memory region MRx may have a next error level value Exn. The next error level value Exn may exceed the threshold error level value Eth. The reclaim operation RCL of the first target memory region MRx may be needed before a first target time point Tpx at which the first target memory region MRx has the threshold error level value Eth.

In a second operation S820, the ECC engine 113 may receive raw data corresponding to the read operation RD. The ECC engine 113 may perform the error correction operation of the raw data and may obtain the current error level value Exc obtained by the error correction operation. The ECC engine 113 may provide the current error level value Exc to the reclaim manager 111.

In a third operation S830, the reclaim manager 111 may determine that the current error level value Exc does not exceed the threshold error level value Eth. In response to determining that the current error level value Exc does not exceed the threshold error level value Eth, the reclaim manager 111 may provide the first target distribution model information DMIx of the first target memory region MRx to the error predictor 112. The reclaim manager 111 may provide information about the current time point Tpc and the current error level value Exc to the error predictor 112.

In a fourth operation S840, the error predictor 112 may calculate the next error level value Exn of the first target memory region MRx at the next time point Tpn at which the reference time period passes from the current time point Tpc, based on the first target distribution model information DMIX.

In a fifth operation S850, the error predictor 112 may determine that the next error level value Exn exceeds the threshold error level value Eth. That is, before the execution of the read operation RD of the next period, the reclaim operation RCL of the first target memory region MRx may need to be performed.

In a sixth operation S860, the error predictor 112 may calculate the first target time point Tpx, at which the first target memory region MRx is predicted as having the threshold error level value Eth, based on the first target distribution model information DMIx. The first target time point Tpx may be earlier than the next time point Tpn. The error predictor 112 may provide reclaim time point information indicating the first target time point Tpx to the reclaim manager 111. However, the present disclosure is not limited thereto. For example, the error predictor 112 may calculate the first target time point Tpx corresponding to an error level value smaller than the threshold error level value Eth.

In a seventh operation S870, the reclaim manager 111 may perform the reclaim operation RCL of the first target memory region MRx at the first target time point Tpx, based on the reclaim time point information. The reclaim operation RCL may include the read operation, the write operation, and the delete operation.

For example, the reclaim manager 111 may provide the NVM device 120 with the reclaim request indicating the reclaim operation RCL. The ECC engine 113 may receive raw data corresponding to the reclaim request. The ECC engine 113 may obtain corrected data by performing the error correction operation of the raw data and may provide the corrected data to the reclaim manager 111. The reclaim manager 111 may perform the write operation of the corrected data in the memory region MR different from the first target memory region MRx and may perform the delete operation of the first target memory region MRx.

In some embodiments, the error predictor 112 may immediately perform the reclaim operation RCL in response to determining that the next error level value Exn exceeds the threshold error level value Eth. For example, the error predictor 112 may set the first target time point Tpx to be the same as the current time point Tpc or may set the first target time point Tpx to a time point immediately after the current time point Tpc. The reclaim manager 111 may immediately perform the reclaim operation RCL, based on the reclaim time point information indicating the first target time point Tpx.

In some embodiments, the error predictor 112 may set the first target time point Tpx so as to be mapped to the threshold error level value Eth. For example, in response to determining that the next error level value Exn exceeds the threshold error level value Eth, the error predictor 112 may calculate the first target time point Tpx to be mapped to the threshold error level value Eth based on the first target distribution model information DMIx. The reclaim manager 111 may perform the reclaim operation RCL, based on the reclaim time point information indicating the first target time point Tpx.

In some embodiments, the error predictor 112 may determine the first target time point Tpx in consideration of the task scheduling information. The task scheduling information may indicate a schedule of tasks to be internally processed by the storage device 100. For example, in response to determining that the next error level value Exn exceeds the threshold error level value Eth, the error predictor 112 may calculate a threshold time point to be mapped to the threshold error level value Eth based on the first target distribution model information DMIx. The error predictor 112 may determine the first target time point Tpx before the threshold time point, based on the task scheduling information of the storage device 100. The reclaim manager 111 may perform the reclaim operation RCL, based on the reclaim time point information indicating the first target time point Tpx.

FIG. 9 is a block diagram of an electronic device, according to some embodiments of the present disclosure. Referring to FIG. 9, the electronic device 900 may include the reclaim manager 111, the NVM device 120, and a machine learning engine 910. The reclaim manager 111 and the NVM device 120 of FIG. 9 may include and/or may be similar in many respects to the reclaim manager 111 and the NVM device 120 described above with reference to FIGS. 1, 2, 6, and 8, and may include additional features not mentioned above. Consequently, repeated descriptions of the reclaim manager 111 and the NVM device 120 described above with reference to FIGS. 1, 2, 6, and 8 may be omitted for the sake of brevity.

The reclaim manager 111 may manage the reclaim operation of data stored in a memory region of the NVM device 120. For example, the reclaim manager 111 may support the scan operation, a random interval neighbor check (RINC) operation, and a dynamic reclaim operation. However, the present disclosure is not limited in this regard, and the reclaim manager 111 may support other operations of the NVM device 120.

The scan operation may be performed to check the degree of deterioration of a representative memory page of a memory block depending on the reference time period. The scan operation may also be referred to as a patrol read operation or a background media scan operation.

The scan operation may use linear distribution model information LDMI-A, linear distribution model information LDMI-B, and/or predictive distribution model information PDMI. The linear distribution model information LDMI-A may be used to determine a time point at which the reclaim operation is to be performed, based on an initial value and a current measurement value. The linear distribution model information LDMI-B may be used to determine a time point at which the reclaim operation is to be performed, based on a measurement value of an immediately previous period and a current measurement value.

The predictive distribution model information PDMI may refer to distribution model information trained by the machine learning engine 910 based on a plurality of training coordinate data. Each of the plurality of training coordinate data may indicate a pair of a time point and a corresponding error level value. The predictive distribution model information PDMI may be used in the scan operation to determine whether the reclaim operation is needed or may be used in the dynamic reclaim operation separately from the scan operation. As the predictive distribution model information PDMI is capable of being selectively implemented, the predictive distribution model information PDMI is illustrated by a dashed line.

The RINC operation may be performed to check the degree of deterioration depending on a variable time period, based on a read count value (e.g., the number of memory cells determined as storing a bit value of one (1 or “high”) or a bit value of zero (0 or “low”)) and deterioration information.

The dynamic reclaim operation may be performed to variably determine a time point at which the reclaim operation is to be performed, based on the predictive distribution model information PDMI of the memory region, separately from the scan operation.

The machine learning engine 910 may perform the training operation of the predictive distribution model information PDMI based on the plurality of training coordinate data. For example, referring to FIG. 1, the machine learning engine 910 may be implemented as a firmware module of the storage device 100, may be implemented as an on-chip module of the storage device 100, may be implemented by the host device 11 communicating with the storage device 100, or may be implemented as a separate hardware accelerator communicating with the storage device 100.

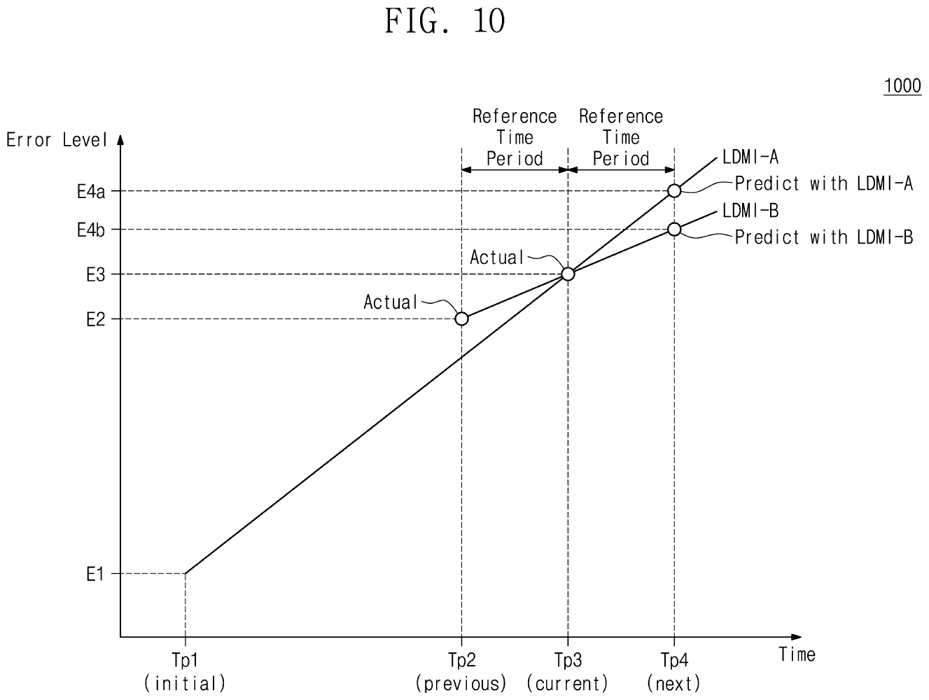

FIG. 10 is a graph describing linear distribution model information of FIG. 9, according to some embodiments of the present disclosure. The linear distribution model information LDMI-A and the linear distribution model information LDMI-B are described with reference to FIGS. 9 and 10. In the graph 1000 of FIG. 10, the horizontal axis represents a time, and the vertical axis represents an error level.

The linear distribution model information LDMI-A may indicate a linear function passing through initial coordinate data and current coordinate data. The initial coordinate data may include a pair of an initial time point Tp1 and a corresponding initial error level value E1. The initial time point Tp1 may indicate an initial time point immediately after data are stored in the target memory region. The initial error level value E1 may indicate the number of error bits of the target memory region at the initial time point Tp1. The current coordinate data may include a pair of a current time point Tp3 and a corresponding current error level value E3.

The current time point Tp3 may indicate a time point at which the scan operation of a current period is performed. The current error level value E3 may indicate the number of error bits of the target memory region at the current time point Tp3. The current time point Tp3 and the current error level value E3 may respectively correspond to the current time point Tpc and the current error level value Exc of FIG. 8.

The reclaim manager 111 may calculate an first next error level value E4a of a next time point Tp4, at which the reference time period passes from the current time point Tp3, based on the linear distribution model information LDMI-A. The next time point Tp4 may correspond to a next period. The first next error level value E4a may indicate the number of error bits of the target memory region, which may be predicted by the linear distribution model information LDMI-A. The linear distribution model information LDMI-A and the first next error level value E4a may respectively correspond to the first target distribution model information DMIx and the next error level value Exn of FIG. 8.

The linear distribution model information LDMI-B may indicate a linear function passing through previous coordinate data and the current coordinate data. The previous coordinate data may include a pair of a previous time point Tp2 and a corresponding previous error level value E2. The previous time point Tp2 may be advanced with respect to the current time point Tp3 as much as the reference time period. The previous time point Tp2 may correspond to a previous period. The previous error level value E2 may indicate the number of error bits of the target memory region at the previous time point Tp2. The current coordinate data may include a pair of the current time point Tp3 and the corresponding current error level value E3.

The reclaim manager 111 may calculate a second next error level value E4b of a next time point Tp4, at which the reference time period passes from the current time point Tp3, based on the linear distribution model information LDMI-B. The second next error level value E4b may indicate the number of error bits of the target memory region, which may be predicted by the linear distribution model information LDMI-B. The linear distribution model information LDMI-B and the second next error level value E4b may respectively correspond to the first target distribution model information DMIx and the next error level value Exn of FIG. 8.

FIG. 11 is a graph describing predictive distribution model information of FIG. 9, according to some embodiments of the present disclosure. The predictive distribution model information PDMI is described with reference to FIGS. 9 and 11. In graph 1100 of FIG. 11, the horizontal axis represents a time, and the vertical axis represents an error level. The predictive distribution model information PDMI may refer to distribution model information trained by the machine learning engine 910 based on a plurality of training coordinate data.

At a current time point Tp1, the reclaim manager 111 may perform the readout operation of the target memory region depending on the scan operation and/or the dynamic reclaim operation. A current error level value E1c may be obtained based on the error correction operation of raw data corresponding to the read operation. The current time point Tp1 and the current error level value E1c may respectively correspond to the current time point Tpc and the current error level value Exc of FIG. 8.

The reclaim manager 111 may obtain a predicted error level value E1p mapped to the current time point Tp1, based on the predictive distribution model information PDMI. The predictive distribution model information PDMI may correspond to the first target distribution model information DMIx of FIG. 8. The predicted error level value E1p may be different from the current error level value E1c obtained by the actual read operation. The reclaim manager 111 may obtain a correction value CV by subtracting the current error level value E1c from the predicted error level value E1p. That is, the correction value CV may indicate a difference of an actually measured error level value and an error level value predicted by the predictive distribution model information PDMI.

A next time point Tp2 may be a time point at which the reference time period passes from the current time point Tp1. The next time point Tp2 may correspond to a next period. The reclaim manager 111 may obtain a predicted error level value E2p mapped to the next time point Tp2, based on the predictive distribution model information PDMI.

The reclaim manager 111 may obtain a next error level value E2c by subtracting the correction value CV from the predicted error level value E2p. The next error level value E2c may indicate the number of error bits of the target memory region, which may be predicted by the correction value CV and the predictive distribution model information PDMI. The next time point Tp2 and the next error level value E2c may respectively correspond to the next time point Tpn and the next error level value Exn of FIG. 8.

According to embodiments of the present disclosure, the reclaim manager 111 may correct the predictive distribution model information PDMI with the correction value CV based on the current time point Tp1 and the current error level value E1c and may obtain the next error level value E2c based on the predictive distribution model information PDMI corrected by the correction value CV.

Alternatively or additionally, the next error level value E2c may be used to calculate the first target time point Tpx corresponding to the threshold error level value Eth of FIG. 8. For example, referring to FIG. 8 together with FIG. 11, in response to determining that the next error level value E2c exceeds the threshold error level value Eth, the reclaim manager 111 may subtract the correction value CV from a next error level value of the graph 1100 of the predictive distribution model information PDMI and may calculate the first target time point Tpx at which the subtracted error level value coincides with the threshold error level value Eth.

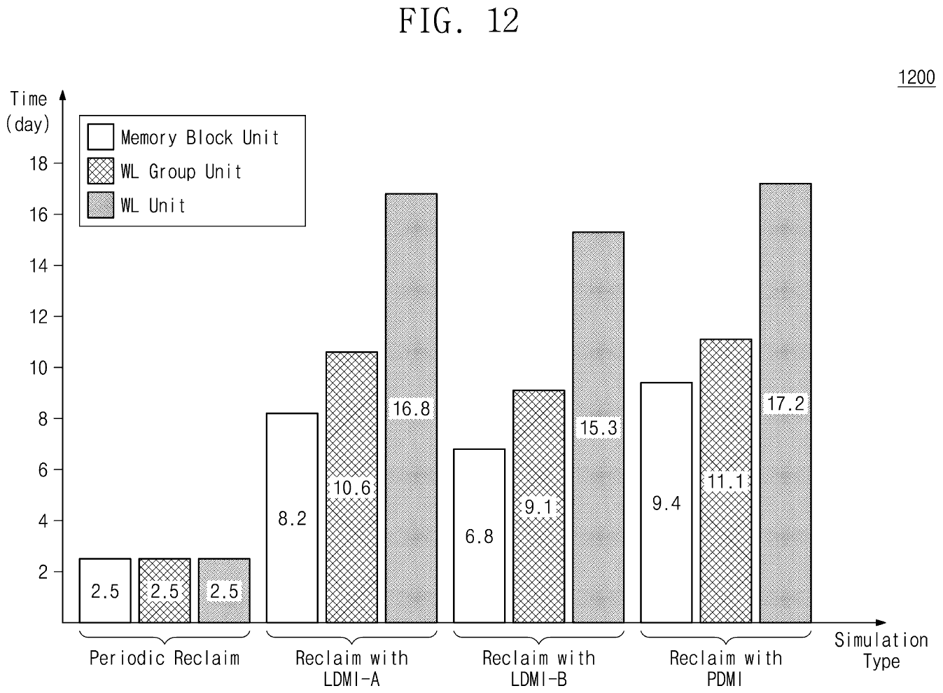

FIG. 12 is a graph describing a simulation of FIG. 9, according to some embodiments of the present disclosure. A reclaim period, according to a simulation type, is described with reference to FIGS. 9 and 12. In graph 1200 of FIG. 12, the horizontal axis represents a simulation type, and the vertical axis represents a time in a day unit.

When the simulation type corresponds to a periodic reclaim, the reclaim manager 111 may manage the reclaim operation without distribution model information. The periodic reclaim may correspond to the reclaim operation RCL of the related storage device SD described with reference to FIG. 5. The periodic reclaim may be performed depending on a condition of a memory region being the poorest from among a plurality of memory regions. For example, when a memory region is set in units of memory block, the reclaim period may be set to 2.5 days, as shown in FIG. 12. As another example, when a memory region is set in units of word line group, the reclaim period may be set to 2.5 days, as further shown in FIG. 12. As another example, when a memory region is set in units of word line, the reclaim period may be set to 2.5 days, as further shown in FIG. 12.

When the simulation type corresponds to a reclaim using the linear distribution model information LDMI-A, the reclaim manager 111 may manage the reclaim operation based on the linear distribution model information LDMI-A. For example, when a memory region is set in units of memory block, the reclaim period may be set to 8.2 days, as shown in FIG. 12. As another example, when a memory region is set in units of word line group, the reclaim period may be set to 10.6 days, as further shown in FIG. 12. As another example, when a memory region is set in units of word line, the reclaim period may be set to 16.8 days, as further shown in FIG. 12.

When the simulation type corresponds to a reclaim using the linear distribution model information LDMI-B, the reclaim manager 111 may manage the reclaim operation based on the linear distribution model information LDMI-B. For example, when a memory region is set in units of memory block, the reclaim period may be set to 6.8 days, as shown in FIG. 12. As another example, when a memory region is set in units of word line group, the reclaim period may be set to 9.1 days, as further shown in FIG. 12. As another example, when a memory region is set in units of word line, the reclaim period may be set to 15.3 days, as further shown in FIG. 12.

When the simulation type corresponds to a reclaim using the predictive distribution model information PDMI, the reclaim manager 111 may manage the reclaim operation based on the predictive distribution model information PDMI. For example, when a memory region is set in units of memory block, the reclaim period may be 9.4 days, as shown in FIG. 12. As another example, when a memory region is set in units of word line group, the reclaim period may be 11.1 days, as further shown in FIG. 12. As another example, when a memory region is set in units of word line, the reclaim period may be 17.2 days, as further shown in FIG. 12.

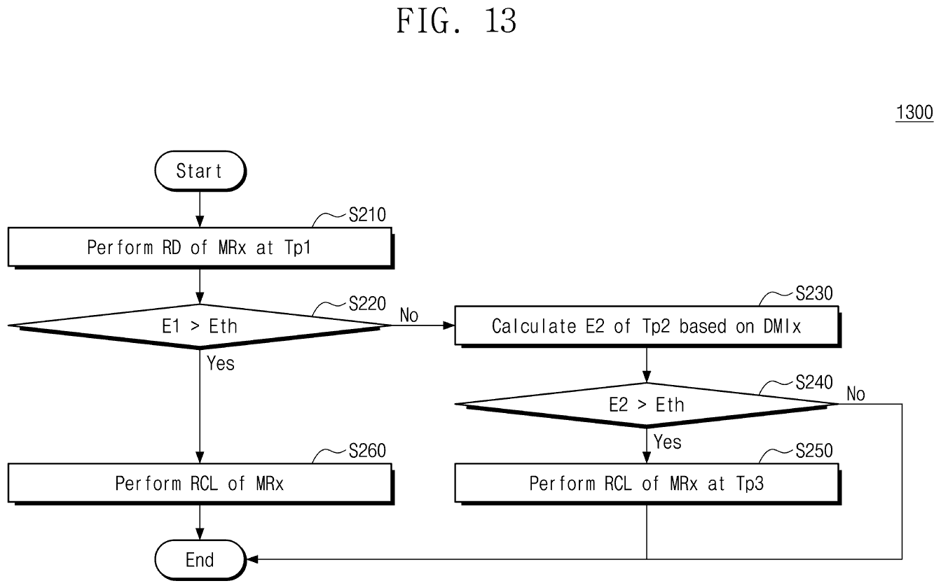

FIG. 13 is a flowchart describing a method of operating a storage device, according to some embodiments of the present disclosure. An example of a method of operating a storage device (e.g., storage device 100 of FIG. 1, storage device 600 of FIG. 6, or storage device 800 of FIG. 8) is described with reference to FIG. 13.

In operation S210, the storage device may perform the read operation RD of the first target memory region MRx at the first time point Tp1. The storage device may obtain a first error level value E1 of the first target memory region MRx by the read operation RD. The first error level value E1 may indicate the number of error bits of the first target memory region MRx at the first time point Tp1. The first time point Tp1 and the error level value E1 may respectively correspond to the current time point Tpc and the current error level value Exc of FIG. 8.

In operation S220, the storage device may determine whether the first error level value E1 exceeds a threshold error level value. The threshold error level value may correspond to the error correction capability of an ECC engine 113 of the storage device. The storage device may perform operation S230 in response to determining that the first error level value E1 does not exceed the threshold error level value (No in operation S220).

In operation S230, the storage device may calculate a second error level value E2 of the second time point Tp2, based on the first target distribution model information DMIx of the first target memory region MRx. The first target distribution model information DMIx may indicate a relationship of a time point and an error level value of the first target memory region MRx. The second time point Tp2 may be a time point at which the reference time period passes from the time point Tp1. The second error level value E2 may indicate a predicted error level value of the first target memory region MRx at the second time point Tp2, based on the first target distribution model information DMIx. The second time point Tp2 and the second error level value E2 may respectively correspond to the next time point Tpn and the next error level value Exn of FIG. 8.

In operation S240, the storage device may determine whether the second error level value E2 exceeds the threshold error level value. The storage device may perform operation S250 in response to determining that the second error level value E2 exceeds the threshold error level value (Yes in operation S240).

In operation S250, the storage device may perform the reclaim operation RCL of the first target memory region MRx at the third time point Tp3 before the second time point Tp2. The third time point Tp3 may correspond to the first target time point Tpx of FIG. 8. The third time point Tp3 may correspond to the threshold error level value Eth or may correspond to an error level value smaller than the threshold error level value Eth.

Returning again to operation S240, the storage device may terminate the operation of the current period in response to determining that the second error level value E2 does not exceed the threshold error level value (No in operation S240). Afterwards, at the second time point Tp2, the storage device may perform a next read operation of the first target memory region MRx depending on a next period. For example, as in the above description given in operation S210, the storage device may again perform the read operation RD of the first target memory region MRx at the second time point Tp2.

Returning again to operation S220, the storage device may perform operation S260 in response to determining that the first error level value E1 exceeds the threshold error level value (Yes in operation S220).

In operation S260, the storage device may perform the reclaim operation RCL of the first target memory region MRx. In such a case, the storage device may immediately perform the reclaim operation RCL.

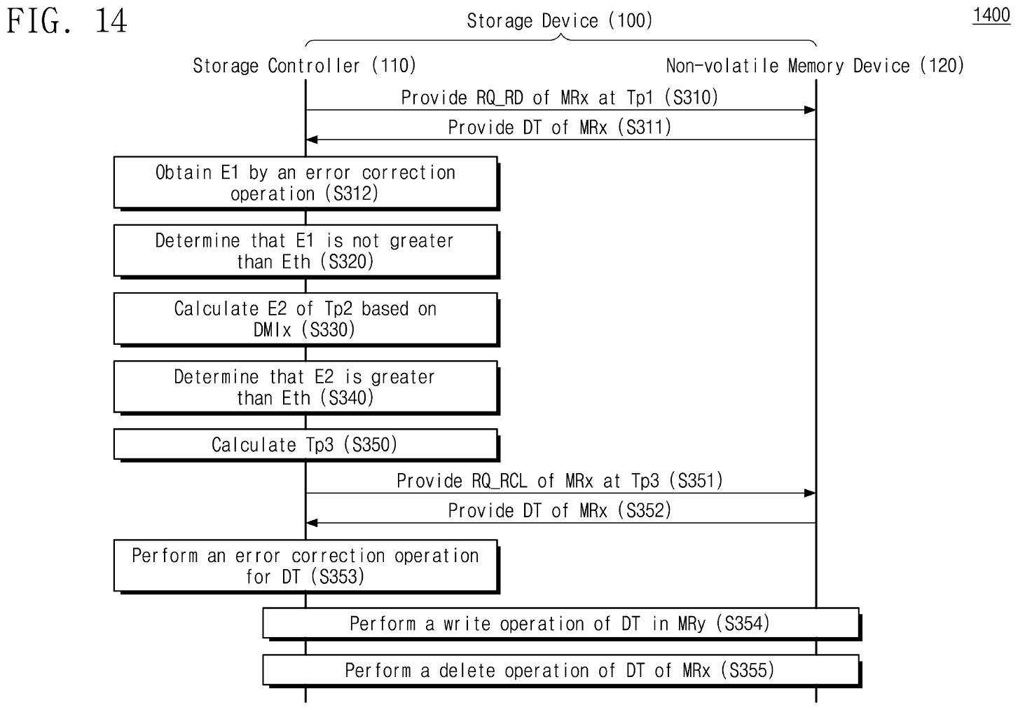

FIG. 14 is a flowchart describing a method of operating a storage device, according to some embodiments of the present disclosure. Referring to FIG. 14, the storage device 100 may include the storage controller 110 and the NVM device 120. The storage controller 110 and the NVM device 120 of FIG. 13 may include and/or may be similar in many respects to storage controller 110 and the NVM device 120 described above with reference to FIGS. 1, 2, 6, and 8, and may include additional features not mentioned above. Consequently, repeated descriptions of storage controller 110 and the NVM device 120 described above with reference to FIGS. 1, 2, 6, and 8 may be omitted for the sake of brevity.

In operation S310, the storage controller 110 may provide the NVM device 120 with a read request RQ_RD of the first target memory region MRx at the first time point Tp1.

In operation S311, the NVM device 120 may provide data DT of the first target memory region MRx to the storage controller 110, based on the read request RQ_RD. The data DT may also be referred to as raw data. The data DT may include error bits.

In operation S312, the ECC engine 113 of the storage controller 110 may perform the error correction operation of the data DT received in operation S311 and may obtain the first error level value E1 by the error correction operation. The first error level value E1 may indicate the number of error bits of the first target memory region MRx at the first time point Tp1.

In operation S320, the storage controller 110 may determine that the first error level value E1 is not greater than the threshold error level value Eth.

In operation S330, the storage controller 110 may calculate the second error level value E2 of the second time point Tp2, based on the first target distribution model information DMIx of the first target memory region MRx. The second error level value E2 may be an error level value predicted by the first target distribution model information DMIx.

In operation S340, the storage controller 110 may determine that the second error level value E2 exceeds the threshold error level value Eth.

In operation S350, the storage controller 110 may calculate the third time point Tp3 earlier than the second time point Tp2.

In operation S351, the storage controller 110 may provide the NVM device 120 with a reclaim request RQ_RCL of the first target memory region MRx at the third time point Tp3. The reclaim operation corresponding to the reclaim request RQ_RCL may include the read operation of the data DT of the first target memory region MRx. In some embodiments, the reclaim request RQ_RCL may be implemented to be similar to the read request RQ_RD.

In operation S352, the NVM device 120 may provide the data DT of the first target memory region MRx to the storage controller 110, based on the reclaim request RQ_RCL. The data DT may include error bits. In such a case, because a time point at which operation S352 is performed is different from a time point at which operation S311 is performed, the number of error bits of the data DT in operation S352 may be different from the number of error bits of the data DT in operation S351.

In operation S353, the storage controller 110 may obtain the corrected data DT by performing the error correction operation of the data DT received in operation S352.

In operation S354, the storage controller 110 may perform the write operation of the corrected data DT in the second target memory region MRy of the NVM device 120, which is different from the first target memory region MRx. For example, the storage controller 110 may provide the NVM device 120 with a write request of the corrected data DT. The NVM device 120 may store the corrected data DT in the second target memory region MRy of the NVM device 120 based on the write request.

In operation S355, the storage controller 110 may perform the delete operation of the data DT in the first target memory region MRx of the NVM device 120. The delete operation may refer to an L2P un-mapping operation in the storage controller 110 (e.g., an operation of deleting a mapping relationship between a logical address identified by the storage controller 110 and a physical address uniquely allocated by the NVM device 120). Alternatively or additionally, the delete operation may refer to a physical erase operation of the NVM device 120.

When the storage device 100 performs the physical erase operation, the storage controller 110 may provide the NVM device 120 with a physical erase request of the data DT of the first target memory region MRx. The NVM device 120 may physically delete the data DT by performing the physical erase operation of the first target memory region MRx based on the physical erase request.

According to an embodiment of the present disclosure, a storage controller for calculating an error level value, a method of operating the storage controller, and a method of operating a storage device including the storage controller are provided.

Additionally, a storage controller, which may be capable of potentially reducing power consumption and a P/E cycle count and improving a device lifetime by performing a reclaim operation at a time point individually predicted for each memory region by distribution model information, instead of performing the reclaim operation depending on a condition of a poor memory region, a method of operating the storage controller, and a method of operating a storage device including the storage controller are provided.

While the present disclosure has been described with reference to embodiments thereof, it is to be apparent to those of ordinary skill in the art that various changes and modifications may be made thereto without departing from the spirit and scope of the present disclosure as set forth in the following claims.

What is claimed is:

1. A method of operating a storage device, the method comprising:
performing, at a first time point, a read operation on a target memory region of the storage device;
obtaining a first error level value based on the performing of the read operation;
determining whether the first error level value exceeds a threshold error level value;
calculating, based on determining that the first error level value does not exceed the threshold error level value, a second error level value corresponding to a second time point, based on distribution model information indicating relationships between time points and error level values of the target memory region, the second time point corresponding to a time point after a reference time period has elapsed from the first time point;
determining whether the second error level value exceeds the threshold error level value; and
performing, at a third time point before the second time point, a reclaim operation on the target memory region, based on determining that the second error level value exceeds the threshold error level value.

2. The method of claim 1, wherein the performing the reclaim operation comprises:
immediately performing the reclaim operation of the target memory region, when the second error level value is determined to exceed the threshold error level value.

3. The method of claim 1, wherein the performing the reclaim operation comprises:
calculating, based on the distribution model information, a threshold time point corresponding to the threshold error level value; and
determining the threshold time point as the third time point.

4. The method of claim 1, wherein the performing the reclaim operation comprises:
calculating, based on the distribution model information, a threshold time point corresponding to the threshold error level value; and
determining, based on task scheduling information of the storage device, a time point before the threshold time point as the third time point.

5. The method of claim 1, wherein the distribution model information comprises linear distribution model information passing through first coordinate data and second coordinate data,
wherein the first coordinate data comprise an initial time point after data are stored in the target memory region and an initial error level value corresponding to the initial time point, and
wherein the second coordinate data comprise the first time point and the first error level value.

6. The method of claim 1, wherein the distribution model information comprises linear distribution model information passing through first coordinate data and second coordinate data,
wherein the first coordinate data comprise a fourth time point advanced from the first time point by the reference time period and a fourth error level value corresponding to the fourth time point, and
wherein the second coordinate data comprise the first time point and the first error level value.

7. The method of claim 1, wherein the distribution model information comprises prediction model information trained by a machine learning engine based on a plurality of training coordinate data.

8. The method of claim 7, wherein the calculating the second error level value comprises:
obtaining, based on the prediction model information, a first predicted error level value corresponding to the first time point;
calculating a correction value by subtracting the first error level value from the first predicted error level value;
obtaining, based on the prediction model information, a second predicted error level value corresponding to the second time point; and
calculating the second error level value by subtracting the correction value from the second predicted error level value.

9. The method of claim 1, wherein the performing the read operation comprises:
providing, to a non-volatile memory device of the storage device at the first time point, a read request of the target memory region;
receiving, based on the read request, raw data of the target memory region; and
obtaining the first error level value by performing an error correction operation of the raw data using an error correction code (ECC) engine of the storage device.

10. The method of claim 1, wherein the performing the reclaim operation comprises:
providing, to a non-volatile memory device of the storage device at the third time point, a reclaim request of the target memory region;
receiving, based on the reclaim request, raw data of the target memory region;
obtaining corrected data by performing an error correction operation of the raw data using an error correction code (ECC) engine of the storage device;
performing a write operation of the corrected data in another memory region of the non-volatile memory device; and
performing a delete operation of the raw data of the target memory region.

11. The method of claim 1, further comprising:
immediately performing the reclaim operation of the target memory region, when the first error level value is determined to exceed the threshold error level value.

12. The method of claim 1, further comprising:
performing, at the second time point, a next read operation of the target memory region, based on determining that the second error level value does not exceed the threshold error level value.

13. A method of operating a storage controller, the method comprising:
providing, to a non-volatile memory device at a first time point, a read request of a target memory region of the non-volatile memory device;
receiving, from the non-volatile memory device, first data corresponding to the read request;
determining whether a first error level value of the first data exceeds a threshold error level value;
calculating, based on determining that the first error level value does not exceed the threshold error level value, a second error level value corresponding to a second time point, based on distribution model information, the second time point corresponding to a time point after a reference time period has elapsed from the first time point;
determining whether the second error level value exceeds the threshold error level value; and
providing, to the non-volatile memory device at a third time point before the second time point, a reclaim request of the target memory region, based on determining that the second error level value exceeds the threshold error level value.

14. The method of claim 13, wherein the determining whether the first error level value of the first data exceeds the threshold error level value comprises:
obtaining the first error level value by performing an error correction operation of the first data using an error correction code (ECC) engine of the storage controller.

15. The method of claim 13, further comprising:
receiving, from the non-volatile memory device, second data corresponding to the reclaim request;
obtaining third data by performing an error correction operation of the second data using an error correction code (ECC) engine of the storage controller;
performing a write operation of the third data in another memory region of the non-volatile memory device; and
performing a delete operation of the target memory region of the non-volatile memory device.

16. A storage controller, comprising:
a memory storing instructions; and
one or more processors communicatively coupled to the memory,
wherein the instructions are configured to, when individually or collectively executed by the one or more processors, cause the storage controller to:
provide, to a non-volatile memory device at a first time point, a read request of a target memory region of the non-volatile memory device;
receive, from the non-volatile memory device, first data corresponding to the read request;
obtain a first error level value by performing a first error correction operation on the first data;
determine whether the first error level value exceeds a threshold error level value;
calculate, based on determining that the first error level value does not exceed the threshold error level value, a second error level value corresponding to a second time point, based on distribution model information, the second time point corresponding to a time point after a reference time period has elapsed from the first time point;
determine whether the second error level value exceeds the threshold error level value;
calculate, based on determining that the second error level value exceeds the threshold error level value, a third time point before the second time point; and
provide reclaim time point information indicating the third time point.

17. The storage controller of claim 16, wherein the instructions are further configured to, when individually or collectively executed by the one or more processors, cause the storage controller to:
provide, to the non-volatile memory device at the third time point, a reclaim request of the target memory region, based on the reclaim time point information;
receive, from the non-volatile memory device, second data corresponding to the reclaim request;
obtain third data by performing an error correction operation of the second data;
perform a write operation of the third data in another memory region of the non-volatile memory device; and
perform a delete operation of the target memory region.

18. The storage controller of claim 16, wherein the non-volatile memory device comprises a plurality of memory blocks,
wherein each of the plurality of memory blocks is coupled with a plurality of word lines, and
wherein the target memory region corresponds to at least one of:
a memory block from among the plurality of memory blocks;
first memory cells coupled with a word line from among the plurality of word lines; or
second memory cells coupled with a word line group comprising at least two word lines from among the plurality of word lines.

19. The storage controller of claim 16, wherein the distribution model information comprises prediction model information trained by a machine learning engine based on a plurality of training coordinate data.

20. The storage controller of claim 19, wherein the machine learning engine is implemented as least one of:
a firmware module of the storage controller;
an on-chip module of the storage controller;
a host device communicating with the storage controller; or
a hardware accelerator communicating with the storage controller.
